(19) United States
(12) Patent Application Publication
(10) Pub. No.: US 2020/0288478 A1
(43) Pub. Date: Sep. 10, 2020

(54) METHOD AND USER EQUIPMENT FOR PERFORMING WIRELESS COMMUNICATION

(71) Applicant: LG ELECTRONICS INC., Seoul (KR)

(72) Inventors: Gyeongcheol LEE, Seoul (KR); Sunyoung LEE, Seoul (KR); Seungjune Yl, Seoul (KR)

(73) Assignee: LG ELECTRONICS INC., Seoul (KR)

(21) Appl. No.: 16/645,443

(22) PCT Filed: Sep. 10, 2018
(86) PCT No.: PCT/KR2018/010529

§ 371 Date: Mar. 6, 2020

Related U.S. Application Data
(60) Provisional application No. 62/555,648, filed on Sep. 8, 2017.

(51) Int. Cl. H04W 72/04; H04L 5/00; H04W 80/02; H04W 72/14

(52) U.S. Cl. CPC H04W 72/0493; H04W 72/14; H04W 80/02; H04L 5/0098

(57) ABSTRACT

The present invention discloses a method of performing, by a user equipment (UE), wireless communications in a wireless communication system, the method comprising: receiving an activation command for activating a SPS resource; activating a cell related to the SPS resource if the cell is a deactivated cell; and activating the SPS resource on the activated cell.

### TECHNICAL FIELD

The present invention relates to a wireless communication system, and more particularly, to a method for performing wireless communications and a device therefor.

### BACKGROUND ART

As an example of a mobile communication system to which the present invention is applicable, a 3rd Generation Partnership Project Long Term Evolution (hereinafter, referred to as LTE) communication system is described in brief.

FIG. 1 is a view schematically illustrating a network structure of an E-UMTS as an exemplary radio communication system. An Evolved Universal Mobile Telecommunications System (E-UMTS) is an advanced version of a conventional Universal Mobile Telecommunications System (UMTS) and basic standardization thereof is currently underway in the 3GPP. E-UMTS may be generally referred to as a Long Term Evolution (LTE) system. For details of the technical specifications of the UMTS and E-UMTS, reference can be made to Release 7 and Release 8 of “3rd Generation Partnership Project; Technical Specification Group Radio Access Network”.

Referring to FIG. 1, the E-UMTS includes a User Equipment (UE), eNode Bs (eNBs), and an Access Gateway (AG) which is located at an end of the network (E-UTRAN) and connected to an external network. The eNBs may simultaneously transmit multiple data streams for a broadcast service, a multicast service, and/or a unicast service.

One or more cells may exist per eNB. The cell is set to operate in one of bandwidths such as 1.25, 2.5, 5, 10, 15, and 20 MHz and provides a downlink (DL) or uplink (UL) transmission service to a plurality of UEs in the bandwidth. Different cells may be set to provide different bandwidths. The eNB controls data transmission or reception to and from a plurality of UEs. The eNB transmits DL scheduling information of DL data to a corresponding UE so as to inform the UE of a time/frequency domain in which the DL data is supposed to be transmitted, coding, a data size, and hybrid automatic repeat and request (HARQ)-related information. In addition, the eNB transmits UL scheduling information of UL data to a corresponding UE so as to inform the UE of a time/frequency domain which may be used by the UE, coding, a data size, and HARQ-related information. An interface for transmitting user traffic or control traffic may be used between eNBs. A core network (CN) may include the AG and a network node or the like for user registration of UEs. The AG manages the mobility of a UE on a tracking area (TA) basis. One TA includes a plurality of cells.

Although wireless communication technology has been developed to LTE based on wideband code division multiple access (WCDMA), the demands and expectations of users and service providers are on the rise. In addition, considering other radio access technologies under development, new technological evolution is required to secure high competitiveness in the future. Decrease in cost per bit, increase in service availability, flexible use of frequency bands, a simplified structure, an open interface, appropriate power consumption of UEs, and the like are required.

As more and more communication devices demand larger communication capacity, there is a need for improved mobile broadband communication compared to existing RAT. Also, massive machine type communication (MTC), which provides various services by connecting many devices and objects, is one of the major issues to be considered in the next generation communication. In addition, a communication system design considering a service/UE sensitive to reliability and latency is being discussed. The introduction of next-generation RAT, which takes into account such advanced mobile broadband communication, massive MTC (mMCT), and ultra-reliable and low latency communication (URLLC), is being discussed.

### DISCLOSURE

### Technical Problem

Due to introduction of new radio communication technology, the number of user equipments (UEs) to which a BS should provide a service in a prescribed resource region increases and the amount of data and control information that the BS should transmit to the UEs increases. Since the amount of resources available to the BS for communication with the UE(s) is limited, a new method in which the BS efficiently receives/transmits uplink/downlink data and/or uplink/downlink control information using the limited radio resources is needed.

With development of technologies, overcoming delay or latency has become an important challenge. Applications whose performance critically depends on delay/latency are increasing. Accordingly, a method to reduce delay/latency compared to the legacy system is demanded.

Also, a method for transmitting/receiving signals effectively in a system supporting new radio access technology is required.

The technical objects that can be achieved through the present invention are not limited to what has been particularly described hereinabove and other technical objects not described herein will be more clearly understood by persons skilled in the art from the following detailed description.

### Technical Solution

In an aspect of the present invention, provided herein is a method of performing, by a user equipment (UE), wireless communications in a wireless communication system. The method comprises: receiving an activation command for activating a semi persistent scheduling (SPS) resource; activating the cell related to the SPS resource if the cell is a deactivated cell; and activating the SPS resource on the activated cell.

In another aspect of the present invention, provided herein is a user equipment for performing wireless communications in a wireless communication system. The UE is equipped with a transceiver, and a processor configured to control the transceiver. The processor may be configured to: control the transceiver to receive an activation command for activating a semi persistent scheduling (SPS) resource; activate the cell related to the SPS resource if the cell is a deactivated cell; and activate the SPS resource on the activated cell.

In a further aspect of the present invention, provided herein is a method of performing, by a base station (BS), wireless communications with a user equipment (UE) in a wireless communication system. The method comprises: transmitting an activation command for activating an SPS resource to the UE; activating a cell related to the SPS resource; and activating the SPS resource on the activated cell.

In a still further aspect of the present invention, provided herein is a base station (BS) for performing wireless communications with a user equipment (UE) in a wireless communication system. The BS is equipped with a transceiver, and a processor configured to control the transceiver. The processor may be configured to: transmit an activation command for activating an SPS resource to the UE; activate a cell related to the SPS resource; and activate the SPS resource on the activated cell.

In each aspect of the present invention, the cell related to the SPS resource may be activated at the UE if the UE receives the activation command for activating the SPS resource, even if the UE does not receive an activation command for the cell.

In each aspect of the present invention, the cell related to the SPS resource may be activated at the BS if the BS transmits the activation command for activating the SPS resource, even if the BS does not transmit a cell activation command for the cell.

In each aspect of the present invention, the SPS resource may be an uplink SPS resource. The UE may transmit a data unit based on the uplink SPS resource on the activated cell. The BS may receive a data unit based on the uplink SPS resource on the activated cell.

In each aspect of the present invention, the SPS resource may be a downlink SPS resource. The UE may receive a data unit based on the downlink SPS resource on the activated cell. The BS may transmit a data unit based on the downlink SPS resource on the activated cell.

In each aspect of the present invention, the cell may be a secondary cell other than a primary cell.

The above technical solutions are merely some parts of the examples of the present invention and various examples into which the technical features of the present invention are incorporated can be derived and understood by persons skilled in the art from the following detailed description of the present invention.

### Advantageous Effects

According to the present invention, radio communication signals can be efficiently transmitted/received. Therefore, overall throughput of a radio communication system can be improved.

According to an example of the present invention, delay/latency occurring during communication between a user equipment and a BS may be reduced.

Also, signals in a new radio access technology system can be transmitted/received effectively.

It will be appreciated by persons skilled in the art that the effects that can be achieved through the present invention are not limited to what has been particularly described hereinabove and other advantages of the present invention will be more clearly understood from the following detailed description.

### DESCRIPTION OF DRAWINGS

The accompanying drawings, which are included to provide a further understanding of the invention, illustrate examples of the invention and together with the description serve to explain the principle of the invention.

FIG. 1 is a view schematically illustrating a network structure of an evolved universal mobile telecommunication system (E-UMTS) as an exemplary radio communication system.

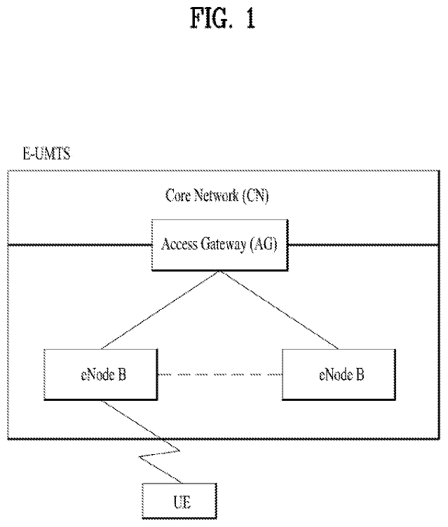

FIG. 2 is a block diagram illustrating network structure of an evolved universal terrestrial radio access network (E-UTRAN).

FIG. 3 is a block diagram depicting architecture of a typical E-UTRAN and a typical EPC.

FIG. 4 is a diagram showing a control plane and a user plane of a radio interface protocol between a UE and an E-UTRAN based on a 3GPP radio access network standard.

FIG. 5 is a view showing an example of a physical channel structure used in an E-UMTS system.

FIG. 6 illustrates an example of protocol stacks of a next generation wireless communication system.

FIG. 7 illustrates a data flow example at a transmitting device in the NR system.

FIG. 8 illustrates a slot structure available in a new radio access technology (NR).

FIG. 9 is a flow diagram illustrating an example of a UE behavior according to the present invention.

FIG. 10 illustrates example operations of a UE according to the present invention.

FIG. 11 is a block diagram illustrating elements of a transmitting device 100 and a receiving device 200 for implementing the present invention.

### MODE FOR INVENTION

Reference will now be made in detail to the exemplary examples of the present invention, examples of which are illustrated in the accompanying drawings. The detailed description, which will be given below with reference to the accompanying drawings, is intended to explain exemplary examples of the present invention, rather than to show the only examples that can be implemented according to the invention. The following detailed description includes specific details in order to provide a thorough understanding of the present invention. However, it will be apparent to those skilled in the art that the present invention may be practiced without such specific details.

In some instances, known structures and devices are omitted or are shown in block diagram form, focusing on important features of the structures and devices, so as not to obscure the concept of the present invention. The same reference numbers will be used throughout this specification to refer to the same or like parts.

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE. For convenience of description, it is assumed that the present invention is applied to 3GPP based wireless communication system. However, the technical features of the present invention are not limited thereto. For example, although the following detailed description is given based on a mobile communication system corresponding to a 3GPP based system, aspects of the present invention that are not limited to 3GPP based system are applicable to other mobile communication systems.

For example, the present invention is applicable to contention based communication such as Wi-Fi as well as non-contention based communication as in the 3GPP based system in which a BS allocates a DL/UL time/frequency resource to a UE and the UE receives a DL signal and transmits a UL signal according to resource allocation of the BS. In a non-contention based communication scheme, an access point (AP) or a control node for controlling the AP allocates a resource for communication between the UE and the AP, whereas, in a contention based communication scheme, a communication resource is occupied through contention between UEs which desire to access the AP. The contention based communication scheme will now be described in brief. One type of the contention based communication scheme is carrier sense multiple access (CSMA). CSMA refers to a probabilistic media access control (MAC) protocol for confirming, before a node or a communication device transmits traffic on a shared transmission medium (also called a shared channel) such as a frequency band, that there is no other traffic on the same shared transmission medium. In CSMA, a transmitting device determines whether another transmission is being performed before attempting to transmit traffic to a receiving device. In other words, the transmitting device attempts to detect presence of a carrier from another transmitting device before attempting to perform transmission. Upon sensing the carrier, the transmitting device waits for another transmission device which is performing transmission to finish transmission, before performing transmission thereof. Consequently, CSMA can be a communication scheme based on the principle of “sense before transmit” or “listen before talk”. A scheme for avoiding collision between transmitting devices in the contention based communication system using CSMA includes carrier sense multiple access with collision detection (CSMA/CD) and/or carrier sense multiple access with collision avoidance (CSMA/CA). CSMA/CD is a collision detection scheme in a wired local area network (LAN) environment. In CSMA/CD, a personal computer (PC) or a server which desires to perform communication in an Ethernet environment first confirms whether communication occurs on a network and, if another device carries data on the network, the PC or the server waits and then transmits data. That is, when two or more users (e.g. PCs, UEs, etc.) simultaneously transmit data, collision occurs between simultaneous transmission and CSMA/CD is a scheme for flexibly transmitting data by monitoring collision. A transmitting device using CSMA/CD adjusts data transmission thereof by sensing data transmission performed by another device using a specific rule. CSMA/CA is a MAC protocol specified in IEEE 802.11 standards. A wireless LAN (WLAN) system conforming to IEEE 802.11 standards does not use CSMA/CD which has been used in IEEE 802.3 standards and uses CA, i.e. a collision avoidance scheme. Transmission devices always sense carrier of a network and, if the network is empty, the transmission devices wait for determined time according to locations thereof registered in a list and then transmit data. Various methods are used to determine priority of the transmission devices in the list and to reconfigure priority. In a system according to some versions of IEEE 802.11 standards, collision may occur and, in this case, a collision sensing procedure is performed. A transmission device using CSMA/CA avoids collision between data transmission thereof and data transmission of another transmission device using a specific rule.

In the present invention, the term “assume” may mean that a subject to transmit a channel transmits the channel in accordance with the corresponding “assumption.” This may also mean that a subject to receive the channel receives or decodes the channel in a form conforming to the “assumption,” on the assumption that the channel has been transmitted according to the “assumption.”

In the present invention, a user equipment (UE) may be a fixed or mobile device. Examples of the UE include various devices that transmit and receive user data and/or various kinds of control information to and from a base station (BS). The UE may be referred to as a terminal equipment (TE), a mobile station (MS), a mobile terminal (MT), a user terminal (UT), a subscriber station (SS), a wireless device, a personal digital assistant (PDA), a wireless modem, a handheld device, etc. In addition, in the present invention, a BS generally refers to a fixed station that performs communication with a UE and/or another BS, and exchanges various kinds of data and control information with the UE and another BS. The BS may be referred to as an advanced base station (ABS), a node-B (NB), an evolved node-B (eNB), a base transceiver system (BTS), an access point (AP), a processing server (PS), etc. Especially, a BS of the UMTS is referred to as a NB, a BS of the EPC/LTE is referred to as an eNB, and a BS of the new radio (NR) system is referred to as a gNB.

In the present invention, a node refers to a fixed point capable of transmitting/receiving a radio signal through communication with a UE. Various types of BSs may be used as nodes irrespective of the terms thereof. For example, a BS, a node B (NB), an e-node B (eNB), a pico-cell eNB (PeNB), a home eNB (HeNB), a relay, a repeater, etc. may be a node. In addition, the node may not be a BS. For example, the node may be a radio remote head (RRH) or a radio remote unit (RRU). The RRH or RRU generally has a lower power level than a power level of a BS. Since the RRH or RRU (hereinafter, RRH/RRU) is generally connected to the BS through a dedicated line such as an optical cable, cooperative communication between RRH/RRU and the BS can be smoothly performed in comparison with cooperative communication between BSs connected by a radio line. At least one antenna is installed per node. The antenna may mean a physical antenna or mean an antenna port or a virtual antenna.

In the present invention, a cell refers to a prescribed geographical area to which one or more nodes provide a communication service. Accordingly, in the present invention, communicating with a specific cell may mean communicating with a BS or a node which provides a communication service to the specific cell. In addition, a DL/UL signal of a specific cell refers to a DL/UL signal from/to a BS or a node which provides a communication service to the specific cell. A node providing UL/DL communication services to a UE is called a serving node and a cell to which UL/DL communication services are provided by the serving node is especially called a serving cell.

Meanwhile, a 3GPP based system uses the concept of a cell in order to manage radio resources and a cell associated with the radio resources is distinguished from a cell of a geographic region.

A “cell” of a geographic region may be understood as coverage within which a node can provide service using a carrier and a “cell” of a radio resource is associated with bandwidth (BW) which is a frequency range configured by the carrier. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of a radio resource used by the node. Accordingly, the term “cell” may be used to indicate service coverage of the node sometimes, a radio resource at other times, or a range that a signal using a radio resource can reach with valid strength at other times.

Meanwhile, the recent 3GPP based wireless communication standard uses the concept of a cell to manage radio resources. The “cell” associated with the radio resources is defined by combination of downlink resources and uplink resources, that is, combination of DL component carrier (CC) and UL CC. The cell may be configured by downlink resources only, or may be configured by downlink resources and uplink resources. If carrier aggregation is supported, linkage between a carrier frequency of the downlink resources (or DL CC) and a carrier frequency of the uplink resources (or UL CC) may be indicated by system information. For example, combination of the DL resources and the UL resources may be indicated by linkage of system information block type 2 (SIB2). In this case, the carrier frequency may be a center frequency of each cell or CC. A cell operating on a primary frequency may be referred to as a primary cell (Pcell) or PCC, and a cell operating on a secondary frequency may be referred to as a secondary cell (Scell) or SCC. The carrier corresponding to the Pcell on downlink will be referred to as a downlink primary CC (DL PCC), and the carrier corresponding to the Pcell on uplink will be referred to as an uplink primary CC (UL PCC). A Scell means a cell that may be configured after completion of radio resource control (RRC) connection establishment and used to provide additional radio resources. The Scell may form a set of serving cells for the UE together with the Pcell in accordance with capabilities of the UE. The carrier corresponding to the Scell on the downlink will be referred to as downlink secondary CC (DL SCC), and the carrier corresponding to the Scell on the uplink will be referred to as uplink secondary CC (UL SCC). Although the UE is in RRC-CONNECTED state, if it is not configured by carrier aggregation or does not support carrier aggregation, a single serving cell configured by the Pcell only exists.

If a UE is configured with one or more SCells, the network may activate and deactivate the configured SCells. The special cell (SpCell) is always activated. The network activates and deactivates the SCell(s) by sending the Activation/Deactivation MAC control element (CE) described. Furthermore, the MAC entity at each of the UE and the network maintains a timer referred to as the sCellDeactivationTimer per configured SCell (except the SCell configured with PUCCH, if any) and deactivates the associated SCell upon expiry of the timer. The same initial timer value applies to each instance of the sCellDeactivationTimer and the initial timer value is configured by RRC. The configured SCells are initially deactivated upon addition and after a handover. The configured secondary cell group (SCG) SCells are initially deactivated after a SCG change. For each TTI and for each configured SCell, the following logical flow applies:
if the MAC entity receives an Activation/Deactivation MAC control element in this TTI activating the SCell, the MAC entity shall perform the following operations in the TTI according to the timing defined in the section “Timing for Secondary Cell Activation/Deactivation” of 3GPP TS 36.213:
   activate the SCell; i.e. apply normal SCell operation including: SRS transmissions on the SCell; CQI/PMI/RI/PTI/CRI reporting for the SCell; PDCCH monitoring on the SCell; PDCCH monitoring for the SCell; and PUCCH transmissions on the SCell, if configured.
   start or restart the sCellDeactivationTimer associated with the SCell;
   trigger power headroom reporting (PHR).
else, if the MAC entity receives an Activation/Deactivation MAC control element in this TTI deactivating the SCell; or if the sCellDeactivationTimer associated with the activated SCell expires in this TTI:
   in the TTI according to the timing defined in the section “Timing for Secondary Cell Activation/Deactivation” of 3GPP TS 36.213, the MAC entity shall deactivate the SCell, stop the sCellDeactivationTimer associated with the SCell, and flush all HARQ buffers associated with the SCell.
if PDCCH on the activated SCell indicates an uplink grant or downlink assignment; or if PDCCH on the Serving Cell scheduling the activated SCell indicates an uplink grant or a downlink assignment for the activated SCell, the MAC entity shall:
   restart the sCellDeactivationTimer associated with the SCell.

If the SCell is deactivated, the MAC entity shall not transmit SRS on the SCell; not report CQI/PMI/RI/PTI/CRI for the SCell; not transmit on uplink shared channel (UL-SCH) on the SCell; not transmit on RACH on the SCell; not monitor the PDCCH on the SCell; not monitor the PDCCH for the SCell; not transmit PUCCH on the SCell.

In the LTE system, the Activation/Deactivation MAC control element of one octet or four octets is used for a network to command a UE to activate or deactivate SCell(s) of the UE. The Activation/Deactivation MAC control element with one octet is applied for the case with no serving cell with a serving cell index (ServCellIndex) larger than 7, otherwise the Activation/Deactivation MAC control element with four octets is applied. The Activation/Deactivation MAC control element with one octet includes 7 C-fields (C₁ to C₇ fields) and one R-field, and the Activation/Deactivation MAC control element with four octets includes 31 C-fields of C₁ to C₃₁ and one R-field. If there is a SCell configured with SCellIndex i, the Cᵢ field indicates the activation/deactivation status of the SCell with SCellIndex i, else the MAC entity ignores the Cᵢ field. The Cᵢ field is set to “1” to indicate that the SCell with SCellIndex i shall be activated, or set to “0” to indicate that the SCell with SCellIndex i shall be deactivated.

Referring to the section “Timing for Secondary Cell Activation/Deactivation” of 3GPP TS 36.213, the SCell Activation/Deactivation timing in the LTE system is as follows. When a UE receives an activation command for a SCell in subframe n, the corresponding actions in MAC shall be applied no later than the minimum requirement defined in 3GPP TS 36.133 and no earlier than subframe n+8, except for the following: the actions related to CSI reporting on a serving cell which is active in subframe n+8, the actions related to the sCellDeactivationTimer associated with the SCell, and the actions related to CSI reporting on a serving cell which is not active in subframe n+8. The actions related to CSI reporting on a serving cell which is active in subframe n+8 and the actions related to the sCellDeactivationTimer associated with the SCell shall be applied in subframe n+8. The actions related to CSI reporting on a serving cell which is not active in subframe n+8 shall be applied in the earliest subframe after n+8 in which the serving cell is active. When a UE receives a deactivation command for a SCell or the sCellDeactivationTimer associated with the SCell expires in subframe n, the corresponding actions in MAC shall apply no later than the minimum requirement defined in 3GPP TS 36.133, except for the actions related to CSI reporting on a serving cell which is active. The actions related to CSI reporting on a serving cell which is active shall be applied in subframe n+8.

In the present invention, “PDCCH” refers to a PDCCH, an EPDCCH (in subframes when configured), a MTC PDCCH (MPDCCH), for an RN with R-PDCCH configured and not suspended, to the R-PDCCH or, for NB-IoT to the narrowband PDCCH (NPDCCH).

In the present invention, monitoring a channel implies attempting to decode the channel. For example, monitoring a PDCCH implies attempting to decode PDCCH(s) (or PDCCH candidates).

In the present invention, for dual connectivity (DC) operation the term “special Cell” refers to the PCell of the master cell group (MCG) or the PSCell of the secondary cell group (SCG), otherwise the term Special Cell refers to the PCell. The MCG is a group of serving cells associated with a master BS which terminates at least S1-MME, and the SCG is a group of serving cells associated with a secondary BS that is providing additional radio resources for the UE but is not the master BS. The SCG is comprised of a primary SCell (PSCell) and optionally one or more SCells. In dual connectivity, two MAC entities are configured in the UE: one for the MCG and one for the SCG. Each MAC entity is configured by RRC with a serving cell supporting PUCCH transmission and contention based Random Access. In this specification, the term SpCell refers to such cell, whereas the term SCell refers to other serving cells. The term SpCell either refers to the PCell of the MCG or the PSCell of the SCG depending on if the MAC entity is associated to the MCG or the SCG, respectively.

In the present invention, “C-RNTI” refers to a cell RNTI, “SI-RNTI” refers to a system information RNTI, “P-RNTI” refers to a paging RNTI, “RA-RNTI” refers to a random access RNTI, “SC-RNTI” refers to a single cell RNTI″, “SL-RNTI” refers to a sidelink RNTI, and “SPS C-RNTI” refers to a semi-persistent scheduling C-RNTI.

For terms and technologies which are not specifically described among the terms of and technologies employed in this specification, 3GPP LTE/LTE-A standard documents, for example, 3GPP TS 36.211, 3GPP TS 36.212, 3GPP TS 36.213, 3GPP TS 36.300, 3GPP TS 36.321, 3GPP TS 36.322, 3GPP TS 36.323 and 3GPP TS 36.331, and 3GPP NR standard documents, for example, 3GPP TS 38.211, 3GPP TS 38.213, 3GPP TS 38.214, 3GPP TS 38.300, 3GPP TS 38.321, 3GPP TS 38.322, 3GPP TS 38.323 and 3GPP TS 38.331 may be referenced.

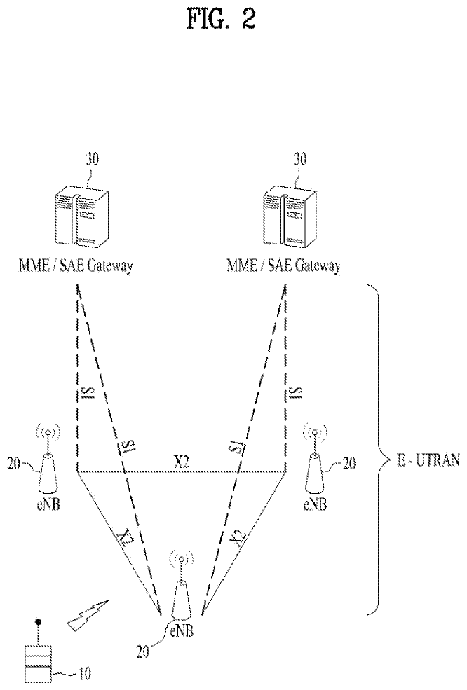

FIG. 2 is a block diagram illustrating network structure of an evolved universal terrestrial radio access network (E-UTRAN). The E-UMTS may be also referred to as an LTE system. The communication network is widely deployed to provide a variety of communication services such as voice (VoIP) through IMS and packet data.

As illustrated in FIG. 2, the E-UMTS network includes an evolved UMTS terrestrial radio access network (E-UTRAN), an Evolved Packet Core (EPC) and one or more user equipment. The E-UTRAN may include one or more evolved NodeB (eNodeB) 20, and a plurality of user equipment (UE) 10 may be located in one cell. One or more E-UTRAN mobility management entity (MME)/system architecture evolution (SAE) gateways 30 may be positioned at the end of the network and connected to an external network.

As used herein, “downlink” refers to communication from BS 20 to UE 10, and “uplink” refers to communication from the UE to a BS.

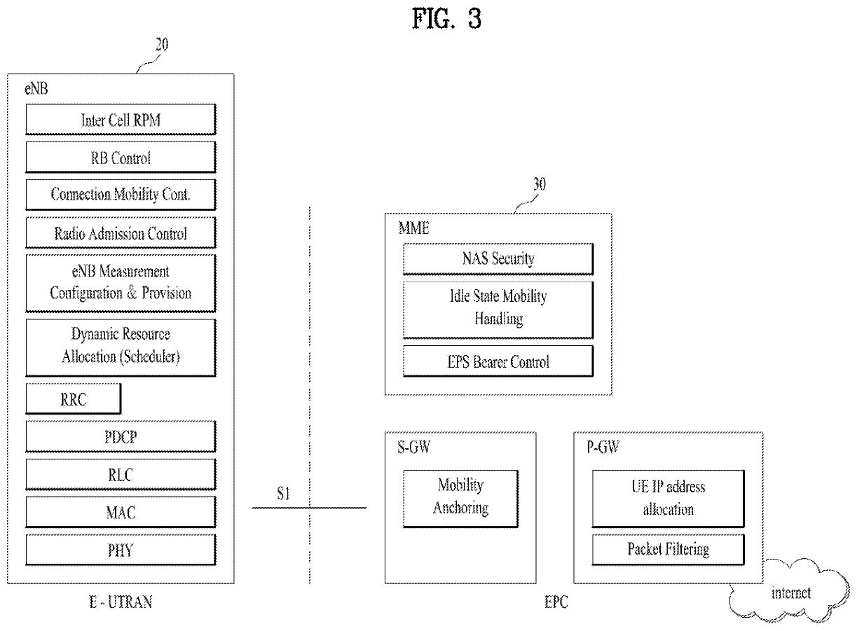

FIG. 3 is a block diagram depicting architecture of a typical E-UTRAN and a typical EPC.

As illustrated in FIG. 3, an eNB 20 provides end points of a user plane and a control plane to the UE 10. MME/SAE gateway 30 provides an end point of a session and mobility management function for UE 10. The eNB and MME/SAE gateway may be connected via S1 interface.

The eNB 20 is generally a fixed station that communicates with a UE 10, and may also be referred to as a base station (BS) or an access point. One eNB 20 may be deployed per cell. An interface for transmitting user traffic or control traffic may be used between eNBs 20.

The MME provides various functions including NAS signaling to eNBs 20, NAS signaling security, access stratum (AS) Security control, Inter CN node signaling for mobility between 3GPP access networks, Idle mode UE Reachability (including control and execution of paging retransmission), Tracking Area list management (for UE in idle and active mode), PDN GW and Serving GW selection, MME selection for handovers with MME change, SGSN selection for handovers to 2G or 3G 3GPP access networks, roaming, authentication, bearer management functions including dedicated bearer establishment, support for PWS (which includes ETWS and CMAS) message transmission. The SAE gateway host provides assorted functions including Per-user based packet filtering (by e.g. deep packet inspection), Lawful Interception, UE IP address allocation, Transport level packet marking in the downlink, UL and DL service level charging, gating and rate enforcement, DL rate enforcement based on APN-AMBR. For clarity MME/SAE gateway 30 will be referred to herein simply as a “gateway,” but it is understood that this entity includes both an MME and a SAE gateway.

A plurality of nodes may be connected between eNB 20 and gateway 30 via the S1 interface. The eNBs 20 may be connected to each other via an X2 interface and neighboring eNBs may have a meshed network structure that has the X2 interface.

As illustrated, eNB 20 may perform functions of selection for gateway 30, routing toward the gateway during a Radio Resource Control (RRC) activation, scheduling and transmitting of paging messages, scheduling and transmitting of Broadcast Channel (BCCH) information, dynamic allocation of resources to UEs 10 in both uplink and downlink, configuration and provisioning of eNB measurements, radio bearer control, radio admission control (RAC), and connection mobility control in LTE ACTIVE state. In the EPC, and as noted above, gateway 30 may perform functions of paging origination, LTE-IDLE state management, ciphering of the user plane, System Architecture Evolution (SAE) bearer control, and ciphering and integrity protection of Non-Access Stratum (NAS) signaling.

The EPC includes a mobility management entity (MME), a serving-gateway (S-GW), and a packet data network-gateway (PDN-GW). The MME has information about connections and capabilities of UEs, mainly for use in managing the mobility of the UEs. The S-GW is a gateway having the E-UTRAN as an end point, and the PDN-GW is a gateway having a packet data network (PDN) as an end point.

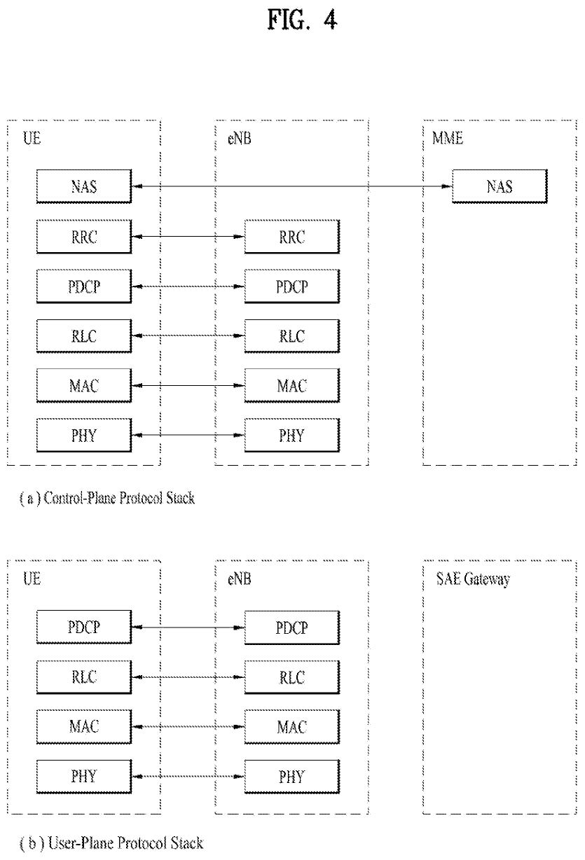

FIG. 4 is a diagram showing a control plane and a user plane of a radio interface protocol between a UE and an E-UTRAN based on a 3GPP radio access network standard. The control plane refers to a path used for transmitting control messages used for managing a call between the UE and the E-UTRAN. The user plane refers to a path used for transmitting data generated in an application layer, e.g., voice data or Internet packet data.

Layer 1 (i.e. L1) of the 3GPP LTE/LTE-A system is corresponding to a physical layer. A physical (PHY) layer of a first layer (Layer 1 or L1) provides an information transfer service to a higher layer using a physical channel. The PHY layer is connected to a medium access control (MAC) layer located on the higher layer via a transport channel. Data is transported between the MAC layer and the PHY layer via the transport channel. Data is transported between a physical layer of a transmitting side and a physical layer of a receiving side via physical channels. The physical channels use time and frequency as radio resources. In detail, the physical channel is modulated using an orthogonal frequency division multiple access (OFDMA) scheme in downlink and is modulated using a single carrier frequency division multiple access (SC-FDMA) scheme in uplink.

Layer 2 (i.e. L2) of the 3GPP LTE/LTE-A system is split into the following sublayers: Medium Access Control (MAC), Radio Link Control (RLC) and Packet Data Convergence Protocol (PDCP). The MAC layer of a second layer (Layer 2 or L2) provides a service to a radio link control (RLC) layer of a higher layer via a logical channel. The RLC layer of the second layer supports reliable data transmission. A function of the RLC layer may be implemented by a functional block of the MAC layer. A packet data convergence protocol (PDCP) layer of the second layer performs a header compression function to reduce unnecessary control information for efficient transmission of an Internet protocol (IP) packet such as an IP version 4 (IPv4) packet or an IP version 6 (IPv6) packet in a radio interface having a relatively small bandwidth.

The main services and functions of the MAC sublayer include: mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ; priority handling between logical channels of one UE; priority handling between UEs by means of dynamic scheduling; MBMS service identification; transport format selection; and padding.

The main services and functions of the RLC sublayer include: transfer of upper layer protocol data units (PDUs); error correction through ARQ (only for acknowledged mode (AM) data transfer); concatenation, segmentation and reassembly of RLC service data units (SDUs) (only for unacknowledged mode (UM) and acknowledged mode (AM) data transfer); re-segmentation of RLC data PDUs (only for AM data transfer); reordering of RLC data PDUs (only for UM and AM data transfer); duplicate detection (only for UM and AM data transfer); protocol error detection (only for AM data transfer); RLC SDU discard (only for UM and AM data transfer); and RLC re-establishment, except for a NB-IoT UE that only uses Control Plane CIoT EPS optimizations.

The main services and functions of the PDCP sublayer for the user plane include: header compression and decompression (ROHC only); transfer of user data; in-sequence delivery of upper layer PDUs at PDCP re-establishment procedure for RLC AM; for split bearers in DC and LWA bearers (only support for RLC AM), PDCP PDU routing for transmission and PDCP PDU reordering for reception; duplicate detection of lower layer SDUs at PDCP re-establishment procedure for RLC AM; retransmission of PDCP SDUs at handover and, for split bearers in DC and LWA bearers, of PDCP PDUs at PDCP data-recovery procedure, for RLC AM; ciphering and deciphering; timer-based SDU discard in uplink. The main services and functions of the PDCP for the control plane include: ciphering and integrity protection; and transfer of control plane data. For split and LWA bearers, PDCP supports routing and reordering. For DRBs mapped on RLC AM and for LWA bearers, the PDCP entity uses the reordering function when the PDCP entity is associated with two AM RLC entities, when the PDCP entity is configured for a LWA bearer; or when the PDCP entity is associated with one AM RLC entity after it was, according to the most recent reconfiguration, associated with two AM RLC entities or configured for a LWA bearer without performing PDCP re-establishment.

Layer 3 (i.e. L3) of the LTE/LTE-A system includes the following sublayers: Radio Resource Control (RRC) and Non Access Stratum (NAS). A radio resource control (RRC) layer located at the bottom of a third layer is defined only in the control plane. The RRC layer controls logical channels, transport channels, and physical channels in relation to configuration, reconfiguration, and release of radio bearers (RBs). An RB refers to a service that the second layer provides for data transmission between the UE and the E-UTRAN. To this end, the RRC layer of the UE and the RRC layer of the E-UTRAN exchange RRC messages with each other. The non-access stratum (NAS) layer positioned over the RRC layer performs functions such as session management and mobility management.

Radio bearers are roughly classified into (user) data radio bearers (DRBs) and signaling radio bearers (SRBs). SRBs are defined as radio bearers (RBs) that are used only for the transmission of RRC and NAS messages.

In LTE, one cell of the eNB is set to operate in one of bandwidths such as 1.25, 2.5, 5, 10, 15, and 20 MHz and provides a downlink or uplink transmission service to a plurality of UEs in the bandwidth. Different cells may be set to provide different bandwidths.

Downlink transport channels for transmission of data from the E-UTRAN to the UE include a broadcast channel (BCH) for transmission of system information, a paging channel (PCH) for transmission of paging messages, and a downlink shared channel (SCH) for transmission of user traffic or control messages. Traffic or control messages of a downlink multicast or broadcast service may be transmitted through the downlink SCH and may also be transmitted through a separate downlink multicast channel (MCH).

Uplink transport channels for transmission of data from the UE to the E-UTRAN include a random access channel (RACH) for transmission of initial control messages and an uplink SCH for transmission of user traffic or control messages. Logical channels that are defined above the transport channels and mapped to the transport channels include a broadcast control channel (BCCH), a paging control channel (PCCH), a common control channel (CCCH), a multicast control channel (MCCH), and a multicast traffic channel (MTCH).

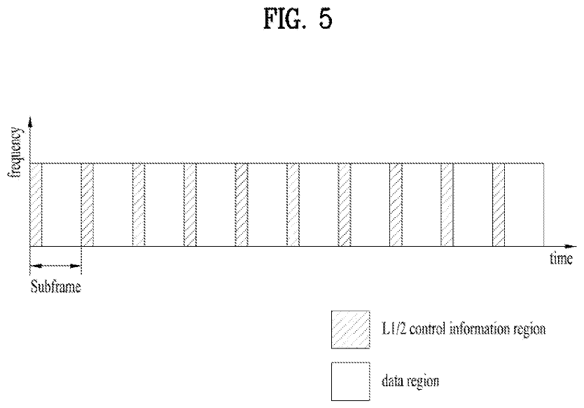

FIG. 5 is a view showing an example of a physical channel structure used in an E-UMTS system. A physical channel includes several subframes on a time axis and several subcarriers on a frequency axis. Here, one subframe includes a plurality of symbols on the time axis. One subframe includes a plurality of resource blocks and one resource block includes a plurality of symbols and a plurality of subcarriers. In addition, each subframe may use certain subcarriers of certain symbols (e.g., a first symbol) of a subframe for a physical downlink control channel (PDCCH), that is, an L1/L2 control channel. The PDCCH carries scheduling assignments and other control information. In FIG. 5, an L1/L2 control information transmission area (PDCCH) and a data area (PDSCH) are shown. In one example, a radio frame of 10 ms is used and one radio frame includes 10 subframes. In addition, in LTE, one subframe includes two consecutive slots. The length of one slot may be 0.5 ms. In addition, one subframe includes a plurality of OFDM symbols and a portion (e.g., a first symbol) of the plurality of OFDM symbols may be used for transmitting the L1/L2 control information.

A time interval in which one subframe is transmitted is defined as a transmission time interval (TTI). Time resources may be distinguished by a radio frame number (or radio frame index), a subframe number (or subframe index), a slot number (or slot index), and the like. TTI refers to an interval during which data may be scheduled. For example, in the 3GPP LTE/LTE-A system, an opportunity of transmission of an UL grant or a DL grant is present every 1 ms, and the UL/DL grant opportunity does not exists several times in less than 1 ms. Therefore, the TTI in the legacy 3GPP LTE/LTE-A system is lms.

A base station and a UE mostly transmit/receive data via a PDSCH, which is a physical channel, using a downlink shared channel (DL-SCH) which is a transmission channel, except a certain control signal or certain service data. Information indicating to which UE (one or a plurality of UEs) PDSCH data is transmitted and how the UE receive and decode PDSCH data is transmitted in a state of being included in the PDCCH.

For example, in one example, a certain PDCCH is CRC-masked with a radio network temporary identity (RNTI) “A” and information about data is transmitted using a radio resource “B” (e.g., a frequency location) and transmission format information “C” (e.g., a transmission block size, modulation, coding information or the like) via a certain subframe. Then, one or more UEs located in a cell monitor the PDCCH using its RNTI information. And, a specific UE with RNTI “A” reads the PDCCH and then receive the PDSCH indicated by B and C in the PDCCH information. In the present invention, a PDCCH addressed to an RNTI means that the PDCCH is cyclic redundancy check masked (CRC-masked) with the RNTI. A UE may attempt to decode a PDCCH using the certain RNTI if the UE is monitoring a PDCCH addressed to the certain RNTI.

A fully mobile and connected society is expected in the near future, which will be characterized by a tremendous amount of growth in connectivity, traffic volume and a much broader range of usage scenarios. Some typical trends include explosive growth of data traffic, great increase of connected devices and continuous emergence of new services. Besides the market requirements, the mobile communication society itself also requires a sustainable development of the eco-system, which produces the needs to further improve system efficiencies, such as spectrum efficiency, energy efficiency, operational efficiency and cost efficiency. To meet the above ever-increasing requirements from market and mobile communication society, next generation access technologies are expected to emerge in the near future.

Building upon its success of IMT-2000 (3G) and IMT-Advanced (4G), 3GPP has been devoting its effort to IMT-2020 (5G) development since September 2015. 5G New Radio (NR) is expected to expand and support diverse use case scenarios and applications that will continue beyond the current IMT-Advanced standard, for instance, enhanced Mobile Broadband (eMBB), Ultra Reliable Low Latency Communication (URLLC) and massive Machine Type Communication (mMTC). eMBB is targeting high data rate mobile broadband services, such as seamless data access both indoors and outdoors, and AR/VR applications; URLLC is defined for applications that have stringent latency and reliability requirements, such as vehicular communications that can enable autonomous driving and control network in industrial plants; mMTC is the basis for connectivity in IoT, which allows for infrastructure management, environmental monitoring, and healthcare applications.

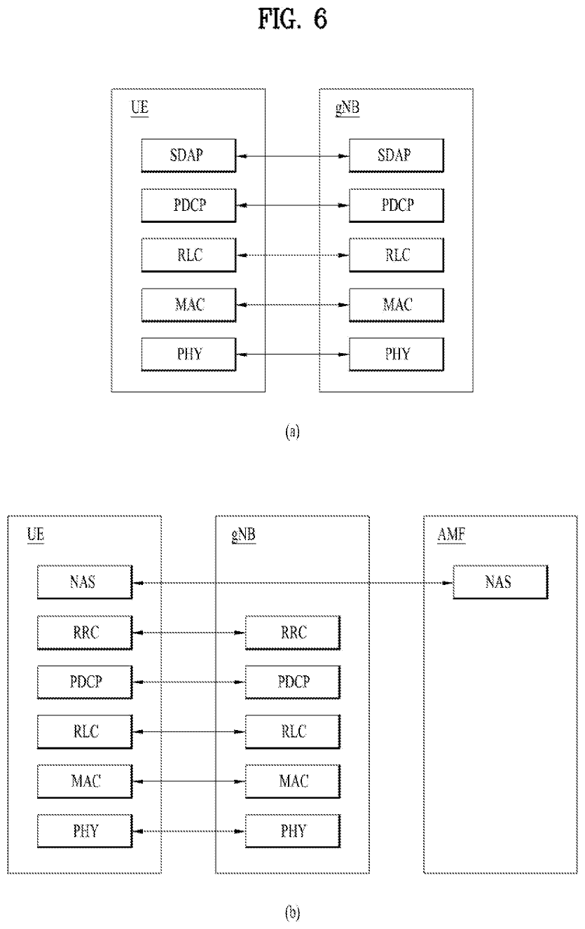

FIG. 6 illustrates an example of protocol stacks of a next generation wireless communication system. In particular, FIG. 6(a) illustrates an example of a radio interface user plane protocol stack between a UE and a gNB and FIG. 6(b) illustrates an example of a radio interface control plane protocol stack between a UE and a gNB.

The control plane refers to a path through which control messages used to manage call by a UE and a network are transported. The user plane refers to a path through which data generated in an application layer, for example, voice data or Internet packet data are transported.

Referring to FIG. 6(a), the user plane protocol stack may be divided into a first layer (Layer 1) (i.e., a physical layer (PHY) layer) and a second layer (Layer 2).

Referring to FIG. 6(b), the control plane protocol stack may be divided into Layer 1 (i.e., a PHY layer), Layer 2, Layer 3 (e.g., a radio resource control (RRC) layer), and a non-access stratum (NAS) layer.

The overall protocol stack architecture for the NR system might be similar to that of the LTE/LTE-A system, but some functionalities of the protocol stacks of the LTE/LTE-A system should be modified in the NR system in order to resolve the weakness or drawback of LTE. RAN WG2 for NR is in charge of the radio interface architecture and protocols. The new functionalities of the control plane include the following: on-demand system information delivery to reduce energy consumption and mitigate interference, two-level (i.e. Radio Resource Control (RRC) and Medium Access Control (MAC)) mobility to implement seamless handover, beam based mobility management to accommodate high frequency, RRC inactive state to reduce state transition latency and improve UE battery life. The new functionalities of the user plane aim at latency reduction by optimizing existing functionalities, such as concatenation and reordering relocation, and RLC out of order delivery. In addition, a new user plane AS protocol layer named as Service Data Adaptation Protocol (SDAP) has been introduced to handle flow-based Quality of Service (QoS) framework in RAN, such as mapping between QoS flow and a data radio bearer, and QoS flow ID marking. Hereinafter the layer 2 according to the current agreements for NR is briefly discussed.

The layer 2 of NR is split into the following sublayers: Medium Access Control (MAC), Radio Link Control (RLC), Packet Data Convergence Protocol (PDCP) and Service Data Adaptation Protocol (SDAP). The physical layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers, and the SDAP sublayer offers to 5GC QoS flows. Radio bearers are categorized into two groups: data radio bearers (DRB) for user plane data and signalling radio bearers (SRB) for control plane data.

The main services and functions of the MAC sublayer of NR include: mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per carrier in case of carrier aggregation); priority handling between UEs by means of dynamic scheduling; priority handling between logical channels of one UE by means of logical channel prioritization; and padding. A single MAC entity can support one or multiple numerologies and/or transmission timings, and mapping restrictions in logical channel prioritization controls which numerology and/or transmission timing a logical channel can use.

The RLC sublayer of NR supports three transmission modes: Transparent Mode (TM); Unacknowledged Mode (UM); Acknowledged Mode (AM). The RLC configuration is per logical channel with no dependency on numerologies and/or TTI durations, and ARQ can operate on any of the numerologies and/or TTI durations the logical channel is configured with. For SRBO, paging and broadcast system information, TM mode is used. For other SRBs AM mode used. For DRBs, either UM or AM mode are used. The main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; Reassembly of SDU (AM and UM); duplicate detection (AM only); RLC SDU discard (AM and UM); RLC re-establishment; and protocol error detection (AM only). The ARQ within the RLC sublayer of NR has the following characteristics: ARQ retransmits RLC PDUs or RLC PDU segments based on RLC status reports; polling for RLC status report is used when needed by RLC; and RLC receiver can also trigger RLC status report after detecting a missing RLC PDU or RLC PDU segment.

The main services and functions of the PDCP sublayer of NR for the user plane include: sequence numbering; header compression and decompression (ROHC only); transfer of user data; reordering and duplicate detection; PDCP PDU routing (in case of split bearers); retransmission of PDCP SDUs; ciphering, deciphering and integrity protection; PDCP SDU discard; PDCP re-establishment and data recovery for RLC AM; and duplication of PDCP PDUs. The main services and functions of the PDCP sublayer of NR for the control plane include: sequence numbering; ciphering, deciphering and integrity protection; transfer of control plane data; reordering and duplicate detection; and duplication of PDCP PDUs.

The main services and functions of SDAP include: mapping between a QoS flow and a data radio bearer; marking QoS flow ID (QFI) in both DL and UL packets. A single protocol entity of SDAP is configured for each individual PDU session. Compared to LTE's QoS framework, which is bearer-based, the 5G system adopts the QoS flow-based framework. The QoS flow-based framework enables flexible mapping of QoS flow to DRB by decoupling QoS flow and the radio bearer, allowing more flexible QoS characteristic configuration.

The main services and functions of RRC sublayer of NR include: broadcast of system information related to access stratum (AS) and non-access stratum (NAS); paging initiated by a 5GC or an NG-RAN; establishment, maintenance, and release of RRC connection between a UE and a NG-RAN (which further includes modification and release of carrier aggregation and further includes modification and release of the DC between an E-UTRAN and an NR or in the NR; a security function including key management; establishment, configuration, maintenance, and release of SRB(s) and DRB(s); handover and context transfer; UE cell selection and re-release and control of cell selection/re-selection; a mobility function including mobility between RATs; a QoS management function, UE measurement report, and report control; detection of radio link failure and discovery from radio link failure; and NAS message transfer to a UE from a NAS and NAS message transfer to the NAS from the UE.

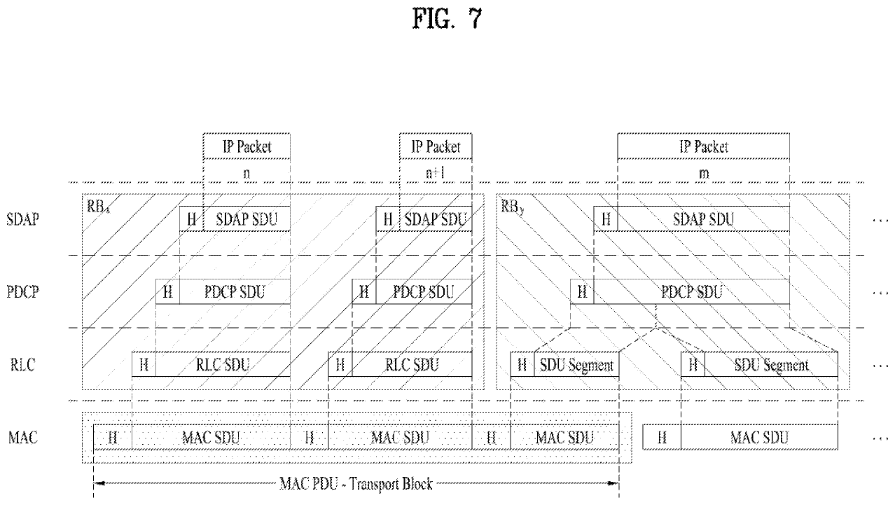

FIG. 7 illustrates a data flow example at a transmitting device in the NR system.

In FIG. 7, an RB denotes a radio bearer. Referring to FIG. 7, a transport block is generated by MAC by concatenating two RLC PDUs from RBₓ and one RLC PDU from RB_{y}. In FIG. 7, the two RLC PDUs from RBₓ each corresponds to one IP packet (n and n+1) while the RLC PDU from RB_{y} is a segment of an IP packet (m). In NR, a RLC SDU segment can be located in the beginning part of a MAC PDU and/or in the ending part of the MAC PDU. The MAC PDU is transmitted/received using radio resources through a physical layer to/from an external device.

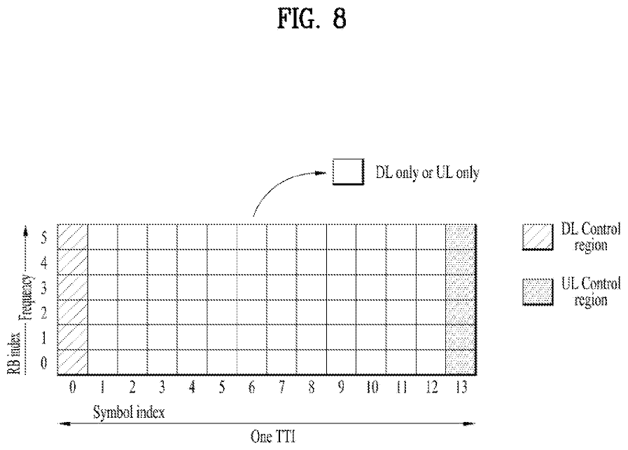

FIG. 8 illustrates a slot structure available in a new radio access technology (NR).

To minimize data transmission latency, in a 5G new RAT, a slot structure in which a control channel and a data channel are time-division-multiplexed is considered.

In FIG. 8, the hatched area represents the transmission region of a DL control channel (e.g., PDCCH) carrying the DCI, and the black area represents the transmission region of a UL control channel (e.g., PUCCH) carrying the UCI. Here, the DCI is control information that the gNB transmits to the UE. The DCI may include information on cell configuration that the UE should know, DL specific information such as DL scheduling, and UL specific information such as UL grant. The UCI is control information that the UE transmits to the gNB. The UCI may include a HARQ ACK/NACK report on the DL data, a CSI report on the DL channel status, and a scheduling request (SR).

In FIG. 8, the region of symbols from symbol index 1 to symbol index 12 may be used for transmission of a physical channel (e.g., a PDSCH) carrying downlink data, or may be used for transmission of a physical channel (e.g., PUSCH) carrying uplink data. According to the slot structure of FIG. 8, DL transmission and UL transmission may be sequentially performed in one slot, and thus transmission/reception of DL data and reception/transmission of UL ACK/NACK for the DL data may be performed in one slot. As a result, the time taken to retransmit data when a data transmission error occurs may be reduced, thereby minimizing the latency of final data transmission.

In such a slot structure, a time gap is needed for the process of switching from the transmission mode to the reception mode or from the reception mode to the transmission mode of the gNB and UE. On behalf of the process of switching between the transmission mode and the reception mode, some OFDM symbols at the time of switching from DL to UL in the slot structure are set as a guard period (GP).

In the legacy LTE/LTE-A system, a DL control channel is time-division-multiplexed with a data channel and a PDCCH, which is a control channel, is transmitted throughout an entire system band. However, in the new RAT, it is expected that a bandwidth of one system reaches approximately a minimum of 100 MHz and it is difficult to distribute the control channel throughout the entire band for transmission of the control channel. For data transmission/reception of a UE, if the entire band is monitored to receive the DL control channel, this may cause increase in battery consumption of the UE and deterioration in efficiency. Accordingly, in the present invention, the DL control channel may be locally transmitted or distributively transmitted in a partial frequency band in a system band, i.e., a channel band.

In the NR system, the basic transmission unit is a slot. A duration of the slot includes 14 symbols having a normal cyclic prefix (CP) or 12 symbols having an extended CP. In addition, the slot is scaled in time as a function of a used subcarrier spacing.

In the NR system, a scheduler (e.g. BS) assigns radio resources in a unit of slot (e.g. one mini-slot, one slot, or multiple slots), and thus the length of one TTI in NR may be different from 1 ms.

In the 3GPP based communication system (e.g. LTE, NR), a UL radio resource assigned by a scheduler is referred to as a UL grant, and a DL radio resource assigned by a scheduler is referred as a DL assignment. A UL grant or DL assignment is dynamically indicated by a PDCCH or semi-persistently configured by a RRC signaling. A UL grant or DL assignment configured semi-persistently is especially referred to as a configured UL grant or configured DL assignment.

Downlink assignments transmitted on the PDCCH indicate if there is a transmission on a downlink shared channel (DL-SCH) for a particular MAC entity and provide the relevant HARQ information. In order to transmit on the uplink shared channel (UL-SCH) the MAC entity must have a valid uplink grant which it may receive dynamically on the PDCCH or in a Random Access Response or which may be configured semi-persistently or pre-allocated by RRC.

In the LTE system, when Semi-Persistent Scheduling is enabled by RRC, the following information is provided (see 3GPP TS 36.331): Semi-Persistent Scheduling C-RNTI or UL Semi-Persistent Scheduling V-RNTI; uplink Semi-Persistent Scheduling interval semiPersistSchedIntervalUL and number of empty transmissions before implicit release implicitReleaseAfter, if Semi-Persistent Scheduling with Semi-Persistent Scheduling C-RNTI is enabled for the uplink; uplink Semi-Persistent Scheduling interval semiPersistSchedIntervalUL and number of empty transmissions before implicit release implicitReleaseAfter for each SPS configuration, if Semi-Persistent Scheduling with UL Semi-Persistent Scheduling V-RNTI is enabled for the uplink; whether twoIntervalsConfig is enabled or disabled for uplink, only for TDD; downlink Semi-Persistent Scheduling interval semiPersistSchedIntervalDL and number of configured HARQ processes for Semi-Persistent Scheduling numberOfConfSPS-Processes, if Semi-Persistent Scheduling is enabled for the downlink. In the LTE system, after a Semi-Persistent downlink assignment is configured, the MAC entity considers sequentially that the N^{th} assignment occurs in the subframe for which: (10*SFN+subframe)={(10*SFN_{start time}+subframe_{start time})+N*semiPersistSchedIntervalDL} modulo 10240. In the LTE system, after a Semi-Persistent Scheduling uplink grant is configured, the MAC entity:
if twoIntervalsConfig is enabled by upper layer (e.g. RRC layer), sets the Subframe_Offset according to Table 1, and else, sets Subframe_Offset to 0; and
considers sequentially that the N^{th} grant occurs in the subframe for which: (10*SFN+subframe)=[(10*SFN_{start time}+subframe_{start time}) N*semiPersistSchedIntervalUL+Subframe_Offset*(N modulo 2)] modulo 10240, where SFN_{start time} and subframe_{start time} are the system frame number (SFN) and subframe, respectively, at the time the configured uplink grant were (re-)initialised.

TABLE 1

| TDD UL/DL | Position of initial | Subframe_Offset value |
|---|---|---|
| configuration | Semi-Persistent grant | (ms) |
| 0 | N/A | 0 |
| 1 | Subframes 2 and 7 | 1 |
| | Subframes 3 and 8 | −1 |
| 2 | Subframe 2 | 5 |
| | Subframe 7 | −5 |
| 3 | Subframes 2 and 3 | 1 |
| | Subframe 4 | −2 |
| 4 | Subframe 2 | 1 |
| | Subframe 3 | −1 |
| 5 | N/A | 0 |
| 6 | N/A | 0 |

In LTE, SPS were designed to reduce the control channel overhead for VoIP based services. As VoLTE typically requires persistent radio resource allocation at regular interval (e.g. one packet in 20 ms from AMR speech codec), the large number of VoIP calls would cause huge signalling overhead on control signalling unless the radio resources for VoIP is allocated for a long period of time. In LTE, SPS can be configured on a SpCell only and not configured on a SCell. If SPS is configured and activated on the SpCell, a UE can use the configured uplink grant or downlink assignment on the special cell, without scheduling for the SpCell by PDCCH. Recently, however, SPS is not limited to VoIP and it is open to be used to schedule various types of traffic for purpose of PDCCH overhead reduction or latency reduction. It can be considered to configure SPS on a SCell as well as a SpCell, in order to accommodate various use cases of recent SPS.

If SPS resource (e.g. uplink grant or downlink assignment) is configured on a SCell, a UE may use the configured uplink grant or downlink assignment when the SPS is activated, without scheduling for the activated SCell through PDCCH. However, if the SCell is deactivated, the UE does not transmit or receive any MAC PDUs on the deactivated SCell. If the SCell associated with the SPS are deactivated, the UE does not use the configured uplink grant or downlink assignment on the deactivated SCell.

In LTE, a UE can activate a SCell of the UE only if the UE receives an activation command for the SCell from a BS, and UE does not activate a SCell of the UE autonomously. As such, a SCell of LTE is activated only if there is an explicit command for the SCell. A SCell of a UE can be deactivated implicitly by timer called sCellDeactivationTimer. The timer is started or restarted each time the UE receives a scheduling PDCCH or an Activation/Deactivation MAC CE. When the timer expires, the corresponding SCell is deactivated implicitly, i.e. without informing the BS about the SCell deactivation. As the UE does not provide SCell activation or deactivation status information to the BS, the implicit deactivation is likely to lead to cell status mismatch between the UE and the BS. Consequently, there may be conflict between SPS activation and implicit SCell deactivation. For example, the BS may activate SPS on a SCell which was already deactivated implicitly. There is a question about how a UE should behave if the UE receives a SPS activation command for SPS of a SCell when the SCell on which the SPS resource will be configured or activated is deactivated. In the present disclosure, the following UE or BS behavior is proposed in order to solve these problems.

The present disclosure proposes that a UE activate a deactivated SCell when the UE receives SPS activation command for activating a SPS resource on the deactivated SCell.

In the present disclosure, activating a cell may mean applying normal SCell operation including: SRS transmissions on the cell; CQI/PMI/RI/PTI/CRI reporting for the cell; PDCCH monitoring on the cell; PDCCH monitoring for the cell; PUCCH transmissions on the cell, if configured; start or restart the cellDeactivationTimer associated with the cell; and/or trigger PHR.

In the present disclosure, the SPS resource refers to either SPS resource in uplink or in downlink. In other words, in the SPS resource refers to either a configured UL grant or a configured DL assignment.

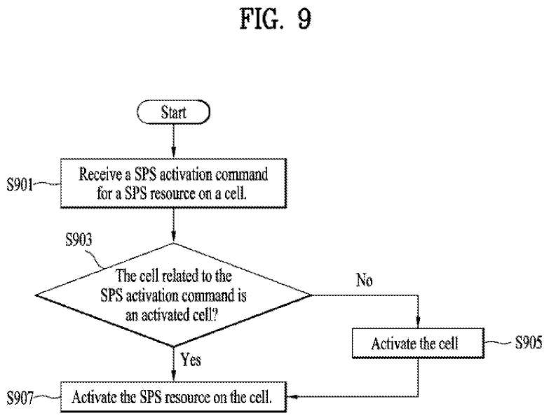

FIG. 9 is a flow diagram illustrating an example of a UE behavior according to the present invention.

For a SCell, a UE may be configured with at least one SPS resource by the network. The network can activate more than one SPS resource simultaneously.

When a SPS activation command for activating a SPS resource is received (S901), the UE checks whether the SCell associated with the SPS resource to be activated by the activation command is in an activated state or in a deactivated state (S903). In other words, the UE determines whether the SCell on which the SPS resource to be activated is active or not, if the UE receives a SPS activation command for activating a SPS resource on the SCell. If the SCell related to the SPS resource to be activated is already in an activated state (S903, Yes), the UE activates the SPS resource on the SCell (S907). If the SCell associated with the SPS resource to be activated is in a deactivated state (S903, No), the UE activates the SCell autonomously (S905). As such, if the SCell associated with the SPS resource to be activated is in a deactivated state, the UE activates the SCell without or before receiving an Activation/Deactivation MAC CE from the network. The UE does not activate another SCell which is not associated with the SPS resource to be activated, unless the UE receives a cell activation command for that SCell or SPS activation command associated with that SCell. If the SCell associated with the SPS resource to be activated has been already activated, the UE may re-activate the SCell. The UE may activate the SPS resource related to the SPS activation command after or upon activating the SCell related to the SPS resource (S907).

After activating the SCell associated with the SPS resource to be activated, the UE transmits or receives a data unit (e.g. MAC PDU) by using the configured uplink grant or the configured downlink assignment on the activated SCell. In a wireless communication system where PCell or PSCell is always activated, the present invention may be applied to SCell(s) only.

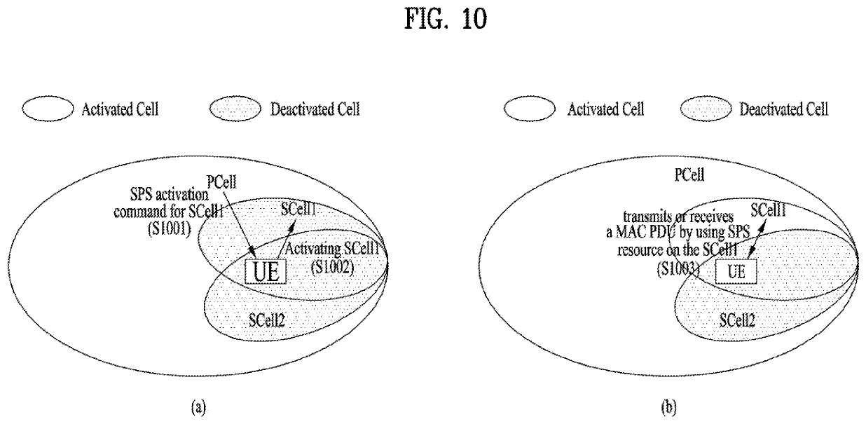

FIG. 10 illustrates example operations of a UE according to the present invention. In particular, FIG. 10(a) illustrates an example operation of a UE when receiving SPS activation command for a deactivated cell, and FIG. 10(b) illustrates an example operation of a UE after activating the deactivated cell by the SPS activation command.

In an example of FIG. 10, the UE is configured with a PCell and two SCells. In the wireless communication system of FIG. 10, PCell is always activated, and SCells may be in either activated or deactivated state.

If the SCell1 and SCell2 are in a deactivated state, the UE transmits a data unit (e.g. MAC PDU) on the PCell only. If the SCell1 and SCell2 are in a deactivated state, the UE does not transmit any MAC PDU on SCell1 and SCell2. In an example of FIG. 10(a), A UE receives a SPS activation command for a cell (e.g. SCell1) via an activated cell (e.g. PCell) (S1001). If a UE receives a SPS activation command for cell(s), the UE checks or determines the activation status of the cell(s) associated with the SPS resource(s) to be activated. In an example of FIG. 10(a), the UE figures out that SCell1, which is associated with the SPS resource to be activated, is in a deactivated state. Then, the UE activates the SCell1 which is associated with the SPS resource to be activated (S1002). However, the UE does not activate SCell2 which is not associated with the SPS resource(s) to be activated.

In an example of FIG. 10(b), after the SCell1 has been activated, the UE can start to use SPS resources on the SCell1. Then, the UE transmits a MAC PDU by using the SPS resource on the activated SCell1 (S1003). Later on, when the SPS deactivation command for the SPS resource on SCell1 is received, the UE stops using SPS resources on the SCell1. However, the UE does not change the activation status of the SCell1. In other words, although the SPS resource on the SCell1 is deactivated, the SCell1 remain activated. The PCell remains activated and the SCell2 remains deactivated, as the SPS deactivation command for the SCell1 is not related to the PCell and the SCell2.

The example(s) of the present invention disclosed herein may also be applied to the network side (e.g. BS) in a similar manner to that of a UE, since the cell activation/deactivation status and/or SPS activation/deactivation status should be synchronized between the UE and the network. For example, the network transmitting a SPS activation command for a cell always may make the cell activated, regardless of the cell's activation/deactivation status recognized by the network.

If a UE is configured to activate SPS on an activated cell only and if the UE is configured to disregard a SPS activation command for a deactivated cell and not to activate SPS on the deactivated cell, there are following problems. If a cell associated with a SPS activation command has been deactivated in a UE, a BS would not receive a SPS confirmation MAC CE from the UE after sending the SPS activation command for the cell to the UE, because the UE cannot configure SPS resources on the deactivated cell. Then, the BS would try again to activate the SPS resources on the deactivated cell, due to cell status mismatch between the UE and the BS. In other words, the BS would try again to activate the SPS resources on the cell by sending the SPS activation command for the cell again, since the BS regards the cell associated with the SPS activation command as an activated cell but actually the cell has been deactivated at the UE implicitly. This inappropriate trying by the BS may be repeated until the SPS resource on the cell is activated successfully. This would result in a lot of signaling exchange between the BS and the UE, and would not be the expected behavior when the BS activates SPS on a cell. To avoid this problem, a BS that wants to activate SPS resource(s) on a serving cell of a UE should activate the serving cell at the UE by send a cell activation command for the serving cell to the UE before sending a SPS activation command for the serving cell, even when the BS considers that the serving cell is in an activated state.

In the present invention, a UE activates a deactivated cell first if the UE receives an SPS activation command for the deactivated cell and then activates the SPS on the activated cell. The present invention can be used for a BS to activate both a deactivated cell and a SPS resource on the deactivate cell by sending a SPS activation command for the deactivated cell. The present invention is advantageous in that the BS that wants to activate SPS on a deactivated cell does not have to send a cell activation command for the deactivated cell before sending a SPS activation command for the cell, thereby reducing signaling overhead.

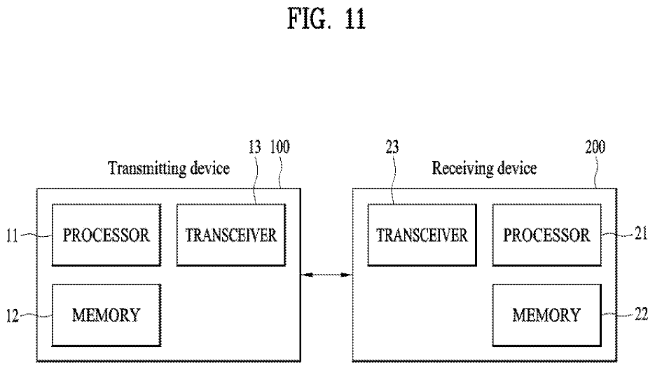

FIG. 11 is a block diagram illustrating elements of a transmitting device 100 and a receiving device 200 for implementing the present invention.

The transmitting device 100 and the receiving device 200 respectively include transceivers 13 and 23 capable of transmitting and receiving radio signals carrying information, data, signals, and/or messages, memories 12 and 22 for storing information related to communication in a wireless communication system, and processors 11 and 21 operationally connected to elements such as the transceivers 13 and 23 and the memories 12 and 22 to control the elements and configured to control the memories 12 and 22 and/or the transceivers 13 and 23 so that a corresponding device may perform at least one of the above-described examples of the present invention.

The memories 12 and 22 may store programs for processing and controlling the processors 11 and 21 and may temporarily store input/output information. The memories 12 and 22 may be used as buffers. The buffers at each protocol layer (e.g. PDCP, RLC, MAC) are parts of the memories 12 and 22.

The processors 11 and 21 generally control the overall operation of various modules in the transmitting device and the receiving device. Especially, the processors 11 and 21 may perform various control functions to implement the present invention. For example, the operations occurring at the protocol stacks (e.g. PDCP, RLC, MAC and PHY layers) according to the present invention may be performed by the processors 11 and 21. The protocol stacks performing operations of the present invention may be parts of the processors 11 and 21.

The processors 11 and 21 may be referred to as controllers, microcontrollers, microprocessors, or microcomputers. The processors 11 and 21 may be implemented by hardware, firmware, software, or a combination thereof. In a hardware configuration, application specific integrated circuits (ASICs), digital signal processors (DSPs), digital signal processing devices (DSPDs), programmable logic devices (PLDs), or field programmable gate arrays (FPGAs) may be included in the processors 11 and 21. Meanwhile, if the present invention is implemented using firmware or software, the firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 100 performs predetermined coding and modulation for a signal and/or data scheduled to be transmitted to the outside by the processor 11 or a scheduler connected with the processor 11, and then transfers the coded and modulated data to the transceiver 13. For example, the processor 11 converts a data stream to be transmitted into K layers through demultiplexing, channel coding, scrambling, and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the transceiver 13 may include an oscillator. The transceiver 13 may include Nₜ (where Nₜ is a positive integer) transmission antennas.

A signal processing process of the receiving device 200 is the reverse of the signal processing process of the transmitting device 100. Under control of the processor 21, the transceiver 23 of the receiving device 200 receives radio signals transmitted by the transmitting device 100. The transceiver 23 may include Nᵣ (where Nᵣ is a positive integer) receive antennas and frequency down-converts each signal received through receive antennas into a baseband signal. The processor 21 decodes and demodulates the radio signals received through the reception antennas and restores data that the transmitting device 100 intended to transmit.

The transceivers 13 and 23 include one or more antennas. An antenna performs a function for transmitting signals processed by the transceivers 13 and 23 to the exterior or receiving radio signals from the exterior to transfer the radio signals to the transceivers 13 and 23. The antenna may also be called an antenna port. Each antenna may correspond to one physical antenna or may be configured by a combination of more than one physical antenna element. The signal transmitted from each antenna cannot be further deconstructed by the receiving device 200. An RS transmitted through a corresponding antenna defines an antenna from the view point of the receiving device 200 and enables the receiving device 200 to derive channel estimation for the antenna, irrespective of whether the channel represents a single radio channel from one physical antenna or a composite channel from a plurality of physical antenna elements including the antenna. That is, an antenna is defined such that a channel carrying a symbol of the antenna can be obtained from a channel carrying another symbol of the same antenna. An transceiver supporting a MIMO function of transmitting and receiving data using a plurality of antennas may be connected to two or more antennas. The transceivers 13 and 23 may be referred to as radio frequency (RF) units.

In the examples of the present invention, a UE operates as the transmitting device 100 in UL and as the receiving device 200 in DL. In the examples of the present invention, a BS operates as the receiving device 200 in UL and as the transmitting device 100 in DL. Hereinafter, a processor, a transceiver, and a memory included in the UE will be referred to as a UE processor, a UE transceiver, and a UE memory, respectively, and a processor, a transceiver, and a memory included in the BS will be referred to as a BS processor, a BS transceiver, and a BS memory, respectively.

The UE processor can be configured to operate according to the present invention, or control the UE transceiver to receive or transmit signals according to the present invention. The BS processor can be configured to operate according to the present invention, or control the BS transceiver to receive or transmit signals according to the present invention.

In the present invention, the UE processor is configured to activate a deactivated cell when the UE receives SPS activation command for activating a SPS resource on the deactivated cell. For a cell, a UE may be configured with at least one SPS resource by the network. The BS processor may control the BS transceiver to transmit SPS configuration information in order to configure at least one SPS resource on a cell to the UE. The BS processor can activate more than one SPS resource simultaneously by sending SPS activation command for more than one SPS resource. The BS processor may be configured to control the BS transceiver to transmit information about SPS resource(s) to be activated. For example, the BS processor may be configured to control the BS transceiver to transmit an activation command for activating SPS resource(s) to the UE.

When a SPS activation command for activating a SPS resource is received by the UE transceiver, the UE processor is configured to check or determine whether the cell associated with the SPS resource to be activated by the activation command is an activated cell or a deactivated cell. If the cell associated with the SPS resource to be activated is a deactivated cell, the UE processor is configured to activate the cell autonomously. As such, if the cell associated with the SPS resource to be activated is a deactivated cell, the UE processor is configured to activate the cell without receiving a cell activation command (e.g. Activation/Deactivation MAC CE) from the BS. The UE processor is configured not to activate another cell which is not associated with the SPS resource to be activated, unless the UE transceiver receives a cell activation command for that cell or SPS activation command associated with that cell. If the cell associated with the SPS resource to be activated has been already activated, the UE process may be configured to re-activate the cell. The UE processor may be configured to activate the SPS resource associated with the SPS activation command after or upon activating the cell associated with the SPS resource. After activating the cell associated with the SPS resource to be activated, the UE processor may be configured to control the UE transceiver to transmit or receive a data unit (e.g. MAC PDU) on the SPS resource configured on the activated cell. As such, in the present disclosure, the UE processor is configured to activate a deactivated cell first if the UE transceiver receives an SPS activation command for the deactivated cell, and then activate the SPS resource(s) on the activated cell.

In the present disclosure, the BS processor may be configured to activate a cell associated with a SPS resource to be activated, when or after the BS processor controls the BS transceiver to transmit an activation command for activating the SPS resource to the UE. The BS processor may control the BS transceiver to transmit a SPS activation command for a SPS resource of a cell, and activate the cell. If the BS processor controls the BS transceiver to transmit a SPS activation command for a cell, the BS processor may activate the cell even if the BS does not transmit a cell activation command for the cell. The BS processor may be configured to control the BS transceiver to transmit a SPS activation command in order to activate both a cell and a SPS resource of the cell. The BS processor may be configured to control the BS transceiver to transmit a data unit on a DL SPS resource activated on the activated cell, or control the BS transceiver to receive a data on a UL SPS resource activated on the activated cell.

As described above, the detailed description of the preferred examples of the present invention has been given to enable those skilled in the art to implement and practice the invention. Although the invention has been described with reference to exemplary examples, those skilled in the art will appreciate that various modifications and variations can be made in the present invention without departing from the spirit or scope of the invention described in the appended claims. Accordingly, the invention should not be limited to the specific examples described herein, but should be accorded the broadest scope consistent with the principles and novel features disclosed herein.

### INDUSTRIAL APPLICABILITY

The examples of the present invention are applicable to a network node (e.g., BS), a UE, or other devices in a wireless communication system.

1. A method of performing, by a user equipment (UE), wireless communications in a wireless communication system, the method comprising:
receiving an activation command for activating a semi persistent scheduling (SPS) resource;
activating the cell related to the SPS resource if the cell is a deactivated cell; and
activating the SPS resource on the activated cell.

2. The method according to claim 1,
wherein the cell related to the SPS resource is activated if the UE receives the activation command for activating the SPS resource, even if the UE does not receive a cell activation command for the cell.

3. The method according to claim 1,
wherein the SPS resource is an uplink SPS resource, and the method further comprises:
transmitting a medium access control (MAC) protocol data unit (PDU) based on the SPS resource on the activated cell.

4. The method according to claim 1,
wherein the SPS resource is a downlink SPS resource, and the method further comprises:
receiving a MAC PDU based on the SPS resource on the activated cell.

5. The method according to claim 1,
wherein the UE is configured with a primary cell and one or more secondary cells (SCells), and the cell is one of the one or more SCells.

6. A user equipment (UE) for performing wireless communications in a wireless communication system, the UE comprising:
a transceiver, and
a processor configured to control the transceiver, the processor configured to:
control the transceiver to receive an activation command for activating a semi persistent scheduling (SPS) resource;
activate the cell related to the SPS resource if the cell is a deactivated cell; and
activate the SPS resource on the activated cell.

7. The UE according to claim 6,
wherein the transceiver is configured to activate the cell related to the SPS resource if the UE receives the activation command for activating the SPS resource, even if the UE does not receive a cell activation command for the cell.

8. The UE according to claim 6,
wherein the SPS resource is an uplink SPS resource, and the processor is configured to:
control the transceiver to transmit a medium access control (MAC) protocol data unit (PDU) based on the SPS resource on the activated cell.

9. The UE according to claim 6,
wherein the SPS resource is a downlink SPS resource, and the processor is configured to:
control the transceiver to receive a MAC PDU based on the SPS resource on the activated cell.

10. The UE according to claim 6,
wherein the UE is configured with a primary cell and one or more secondary cells (SCells), and the cell is one of the one or more SCells.

11. A method of performing, by a base station (BS), wireless communications with a user equipment (UE) in a wireless communication system, the method comprising:
transmitting an activation command for activating an SPS resource to the UE;
activating a cell related to the SPS resource; and
activating the SPS resource on the activated cell.

12. A base station (BS) for performing wireless communications with a user equipment (UE) in a wireless communication system, the BS comprising:
a transceiver, and
a processor configured to control the transceiver, the processor configured to:
transmit an activation command for activating an SPS resource to the UE;
activate a cell related to the SPS resource; and
activate the SPS resource on the activated cell.
